(19) United States
(12) Patent Application Publication
(10) Pub. No.: US 2026/0246547 A1
(43) Pub. Date: Aug. 20, 2026

(54) WIRELESS COMMUNICATION APPARATUS AND METHOD

(71) Applicant: Sony Group Corporation, Tokyo (JP)

(72) Inventor: Shigeru SUGAYA, Kanagawa (JP)

(73) Assignee: Sony Group Corporation, Tokyo (JP)

(21) Appl. No.: 19/164,461

(22) PCT Filed: Mar. 5, 2024
(86) PCT No.: PCT/JP2024/008173

§ 371 Date: Sep. 11, 2025

(30) Foreign Application Priority Data
Mar. 29, 2023 (JP) 2023-053531

(51) Int. Cl. H04B 17/318; H04B 17/309; H04W 24/10

(52) U.S. Cl. CPC H04B 17/318; H04B 17/346; H04W 24/10

(57) ABSTRACT

The present technology relates to a wireless communication apparatus and method that make it possible to operate a wireless LAN system without affecting an existing communication system.

The wireless communication apparatus sets thresholds of a plurality of levels for a received electric field strength of a detected signal, detects that the detected signal is an existing system signal of a predetermined existing system, measures a received electric field strength of the existing system signal, and transmits a predetermined signal to another surrounding wireless communication apparatus when the measured received electric field strength exceeds a threshold of the predetermined existing system among the thresholds of the plurality of levels. The present technology can be applied to a wireless communication system.

### TECHNICAL FIELD

The present technology relates to a wireless communication apparatus and method, and particularly to, a wireless communication apparatus and method that make it possible to operate a wireless local area network (LAN) system without affecting an existing communication system.

### BACKGROUND ART

Currently, a frequency sharing system is being put to practical use as a new way to use radio frequencies, the frequency sharing system being capable of operating a wireless LAN system in the frequency bands used in an existing primary system without affecting the primary system.

In such a frequency sharing system, it has been necessary to operate the wireless LAN system within the range where signals from the primary system are not detected. Therefore, it has also been necessary to determine whether or not the wireless LAN system can be operated in accordance with the location of an access point (AP) of the wireless LAN system.

If the access point is disposed, for example, at an indoor location where the signals are unlikely to leak outdoors, the wireless LAN system can be operated without affecting the primary system.

However, if the geographic location information where the access point is disposed is deemed to be within the range that would affect the existing primary system, the wireless LAN system cannot be operated.

For example, Patent Literature 1 discloses an apparatus that detects whether or not a radio channel is used by the primary system or is in a free state in a cognitive wireless system.

### CITATION LIST

### Patent Literature

Patent Literature 1: Japanese Patent Application Laid-open No. 2007-088940

### DISCLOSURE OF INVENTION

### Technical Problem

The cognitive wireless system described in Patent Literature 1 has a configuration in which a channel available during a valid period is allocated by referring to a database apparatus that holds information relating to a valid period during which a radio channel in a free state can be used.

Therefore, in the cognitive wireless system described in Patent Literature 1, even if an apparatus is located within a network range that does not affect the operation of the primary system, a channel cannot be assigned thereto during the hours when the primary system uses it.

The present technology has been made in view of the circumstances as described above and makes it possible to operate a wireless LAN system without affecting an existing communication system.

### Solution to Problem

A wireless communication apparatus according to one aspect of the present technology includes: a setting section that sets thresholds of a plurality of levels for a received electric field strength of a detected signal; a detection section that detects that the detected signal is an existing system signal of a predetermined existing system; a measurement section that measures a received electric field strength of the existing system signal; and a communication control section that transmits a predetermined signal to another surrounding wireless communication apparatus when the measured received electric field strength exceeds a threshold of the predetermined existing system among the thresholds of the plurality of levels.

In one aspect of the present technology, thresholds of a plurality of levels are set for a received electric field strength of a detected signal, it is detected that the detected signal is an existing system signal of a predetermined existing system, a received electric field strength of the existing system signal is measured, and a predetermined signal is transmitted to another surrounding wireless communication apparatus when the measured received electric field strength exceeds a threshold of the predetermined existing system among the thresholds of the plurality of levels.

### BRIEF DESCRIPTION OF DRAWINGS

FIG. 1 is a diagram showing examples of frequency ranges used in a wireless LAN system and channel allocation.

FIG. 2 is a diagram showing a configuration example of a wireless LAN system according to one embodiment of the present technology.

FIG. 3 is a diagram showing a signal detection status of an existing system in each apparatus.

FIG. 4 is a diagram showing a first sequence for the setup of a detection report parameter.

FIG. 5 is a diagram showing a second sequence for the setup of a detection report parameter.

FIG. 6 is a diagram showing a third sequence for the setup of a detection report parameter.

FIG. 7 is a diagram showing a first detection report sequence of the present technology.

FIG. 8 is a diagram showing a second detection report sequence of the present technology.

FIG. 9 is a diagram showing a third detection report sequence of the present technology.

FIG. 10 is a diagram showing a configuration example of a detection report parameter information element.

FIG. 11 is a diagram showing a configuration example of a parameter change information element.

FIG. 12 is a diagram showing a configuration example of a Detect Indication frame.

FIG. 13 is a diagram showing a configuration example of a Detect Request frame.

FIG. 14 is a diagram showing a configuration example of a Detect Response frame.

FIG. 15 is a diagram showing a fourth detection report sequence in the case of a multilink operation.

FIG. 16 is a diagram showing a fifth detection report sequence in the case of a multilink operation.

FIG. 17 is a diagram showing a sixth detection report sequence in the case of a multilink operation.

FIG. 18 is a block diagram showing a configuration example of a wireless communication apparatus to which the present technology is applied.

FIG. 19 is a block diagram showing a configuration example of a wireless communication module.

FIG. 20 is a flowchart for describing the processing of an STA.

FIG. 21 is a flowchart for describing the processing of the STA, following FIG. 20.

FIG. 22 is a flowchart for describing the processing of an AP.

FIG. 23 is a flowchart for describing the processing of the AP, following FIG. 22.

FIG. 24 is a block diagram showing a configuration example of a computer.

### MODE(S) FOR CARRYING OUT THE INVENTION

Hereinafter, modes for carrying out the present technology will be described. Description will be given in the following order.
1. Wireless LAN System
2. Operation of Wireless LAN System and Frame Configuration
3. Configuration of Wireless Communication Apparatus
4. Operation of Wireless Communication Apparatus
5. Others

### 1. Wireless LAN System

### <Frequency Ranges and Channel Allocation of Wireless LAN System>

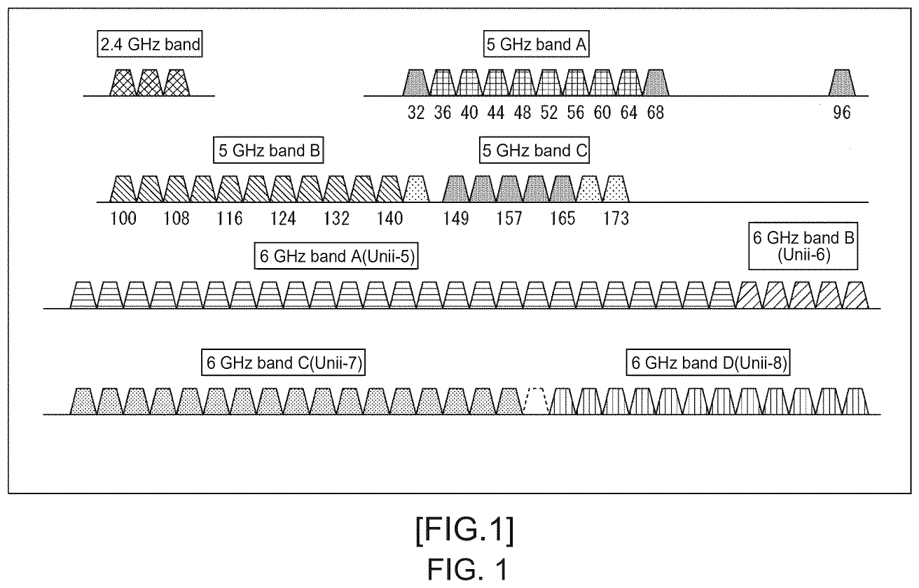

FIG. 1 is a diagram showing examples of frequency ranges used in a wireless LAN system and channel allocation.

FIG. 1 shows available frequency ranges and channel allocation statuses thereof for the wireless LAN system.

First, if the 2.4 GHz band is applied to orthogonal frequency division multiplexing (OFDM) radio signals with 20 MHz-bandwidth in the IEEE802.11g standard, frequency channels corresponding to approximately at least three channels can be set.

Further, in the 5 GHz band, a plurality of channels to be applied to the OFDM radio signals with 20 MHz-bandwidth can be secured for the standards such as the IEEE802.11a.

However, the operation of the 5 GHz band is under the conditions to determine available frequency ranges, transmission power, and transmission availability in the legal system of each country.

In FIG. 1, the channel numbers are provided under the 5 GHz band. In Japan, eight channels of channels 36 through 64 and 11 channels of channels 100 through 140 are available.

Note that, in other countries and regions, channel 32, channel 68, channel 96, and channel 144 are also available, and in the higher frequency range, channels 149 through 173 are available.

For a use method in the 6 GHz band, which is currently being standardized to be available for use, 25 channels in the UNII-5 band in the 6 GHz band A, 5 channels in the UNII-6 band in the 6 GHz band B, 17 channels in the UNII-7 band in the 6 GHz band C, and 12 channels in the UNII-8 band in the 6 GHz band D can be disposed, as shown in FIG. 1.

In those frequency ranges, a plurality of 20 MHz bandwidths can be used, so that two bands can be combined to continuously use 40 MHz bandwidth, four bands can be combined to continuously use 80 MHz bandwidth, and eight bands can be combined to continuously use 160 MHz bandwidth, for example.

Further, the frequency range of the 6 GHz band, in which those standards are being developed, can also be used as a wireless LAN system in the presence of an existing primary system.

In other words, in the frequency range of the 6 GHz band, the wireless LAN system is allowed to be operated only in hours and in geographic locations where existing systems including an existing primary system are not operated.

### <Configuration of Wireless LAN System>

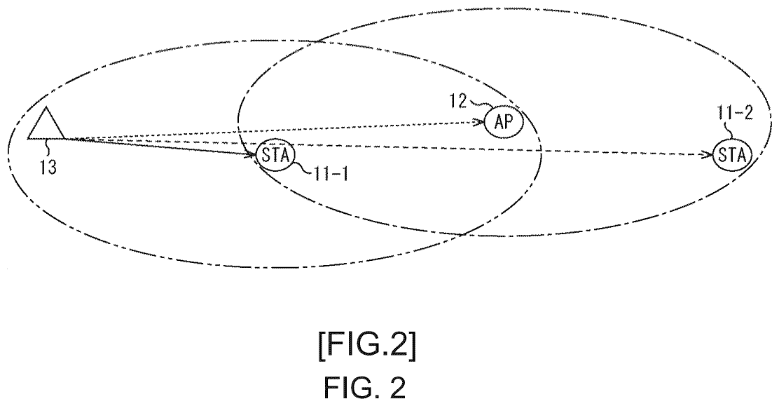

FIG. 2 is a diagram showing a configuration example of a wireless LAN system that is a wireless communication system according to one embodiment of the present technology.

A wireless LAN system of FIG. 2 is configured to include communication terminals (STAs; stations) 11-1 and 11-2 and an access point (AP) 12.

The STAs 11-1 and 11-2 and the AP 12 are mutually connected by wireless communication. Note that the STAs 11-1 and 11-2 are each referred to as STA 11 if there is no need to distinguish between them.

In FIG. 2, for example, on the left side of the figure, there is an apparatus 13 belonging to an existing system (hereinafter, referred to as existing system apparatus). The existing system apparatus 13 transmits predetermined signals as indicated by the arrows.

Note that the arrow of the solid line indicates that signals transmitted from the existing system apparatus 13 (hereinafter, referred to as existing system signal) are detected with a predetermined strength of a received electric field strength (received signal strength indicator (RSSI)) in the STA 11-1. The arrow of the dotted line indicates that the existing system signals are detected with a moderate received electric field strength in the AP 12. The arrow of the broken line indicates that the existing system signals are detected with a small received electric field strength in the STA 11-2.

Further, the ellipse of the dash-dot line indicates a signal reach when the signals are transmitted from the AP 12 with predetermined transmission power. The ellipse of the dash-dot-dot line indicates a signal reach when the signals are transmitted from the STA 11-1 with predetermined transmission power.

In other words, it is assumed that the signals transmitted from the STA 11-1 can be received by the existing system apparatus 13, and it is found that the STA 111-1 is in the range where the operation of the wireless LAN system should be limited.

Note that the STAs 11-1 and 11-2 are located within the signal reach of the AP 12 as indicated by the dash-dot line, and thus the AP 12 can confirm the presence of the STAs 11-1 and 11-2. On the other hand, since the STA 11-2 is not located within the signal reach of the STA 11-1 as indicated by the dash-dot-dot line, the STA 11-1 cannot confirm the presence of the STA 11-2. Similarly, since the STA 11-1 is not located within the signal reach of the STA 11-2 (not shown), the STA 11-2 cannot confirm the presence of the STA 11-1. In other words, the STAs 11-1 and 11-2 are in the state of hidden terminals with each other.

### <Signal Detection Status>

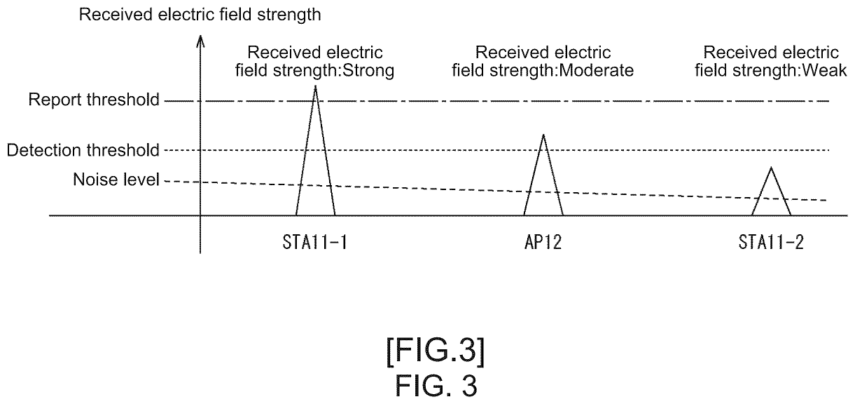

FIG. 3 is a diagram showing a detection status of the existing system signal in the STA 11-1, the AP 12, and the STA 11-2 of the wireless LAN system of FIG. 2.

In FIG. 3, the vertical axis represents the received electric field strength, and the horizontal axis represents a distance of each apparatus from the existing system apparatus 13. In other words, FIG. 3 schematically shows the value of the received electric field strength of the existing system signal in accordance with the distance at which each apparatus is disposed.

Further, the broken line indicates a level that is recognized as the noise floor level (hereinafter, referred to as noise level) in the received electric field strength. The dotted line indicates a detection threshold at which it is determined that the existing system signals have been detected in the received electric field strength. The dash-dot line indicates a report threshold at which it is determined that the detection of the existing system signals is required to be reported in the received electric field strength (noise level<detection threshold<report threshold). The report threshold and the detection threshold are thresholds of the received electric field strength set on the basis of the noise level. Note that FIG. 3 schematically shows that the level of the broken line is not uniform because there are differences in the signal strength of the noise level from the external environment depending on the location where each apparatus is disposed.

It is found from FIG. 3 that the STA 11-1 located closest to the existing system apparatus 13 is in the state where the existing system signals are detected at the report threshold or above. Further, it is found that the AP 12 is in the state where the existing system signals are detected at a value slightly above or below the detection threshold. It is found that the STA 11-2 located farthest away from the existing system apparatus 13 is in the state where the existing system signals are detected at a level corresponding to the value of a stationary noise level. Note that the noise level may be, for example, a signal-to-noise ratio (SNR).

### 2. Operation of Wireless LAN System and Frame Configuration

### <First Sequence for Setup of Detection Report Parameter>

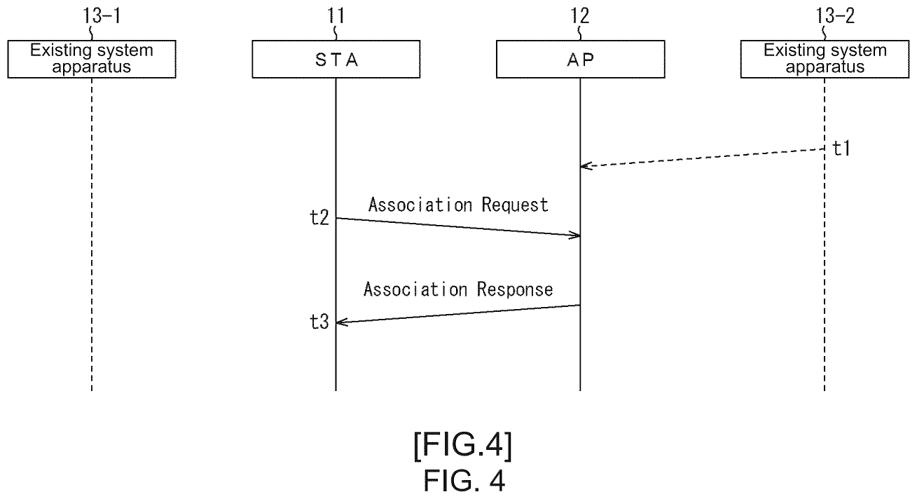

FIG. 4 is a diagram showing a first sequence for the setup of a detection report parameter.

FIG. 4 shows a first sequence in which the STA 11 and the AP 12 exchange a detection report parameter regarding the detection and report of the existing system signals by using a frame exchanged at a timing at which association is executed. The detection report parameter is a parameter that at least includes the report threshold, the detection threshold, and the noise level described above.

Note that an existing system apparatus 13-1 is shown on the left of the STA 11, and an existing system apparatus 13-2 is shown on the right of the AP 12, but only when the arrow of the broken line is indicated with respect to the STA 11 or the AP 12, the existing system apparatuses 13-1 and 13-2 are present around the apparatuses. In other words, in the case of FIG. 4, the existing system apparatus 13-2 is present around the AP 12.

For example, at time t1, the existing system apparatus 13-2 transmits the existing system signal. The AP 12 detects the existing system signal.

At time t2, the STA 11 transmits an Association Request frame to the AP 12 in order to join the network of the wireless LAN system (hereinafter, referred to as wireless LAN network).

At that time, if the existing system apparatus 13-1 is not present around the STA 11, there is no detection of existing system signals, or existing system signals cannot be detected even if the existing system signals are present, and thus it is not necessary to add the detection report parameter to the Association Request frame. However, for example, the noise level may be added to the Association Request frame or the like, as surrounding environment information, to be notified to the AP 12.

At time t3, the AP 12 refers to the information or the like from the existing system signal of the existing system apparatus 13-2 present therearound in the past (e.g., time t1), and sets the report threshold, detection threshold, and noise level described above with reference to FIG. 3. The AP 12 transmits, for example, an Association Response frame to which the detection report parameter including the set thresholds has been added, to the STA 11.

Thus, in the STA 11, it is possible to understand the setting status of each threshold of the AP 12 in the wireless LAN system and to set each threshold.

### <Second Sequence for Setup of Detection Report Parameter>

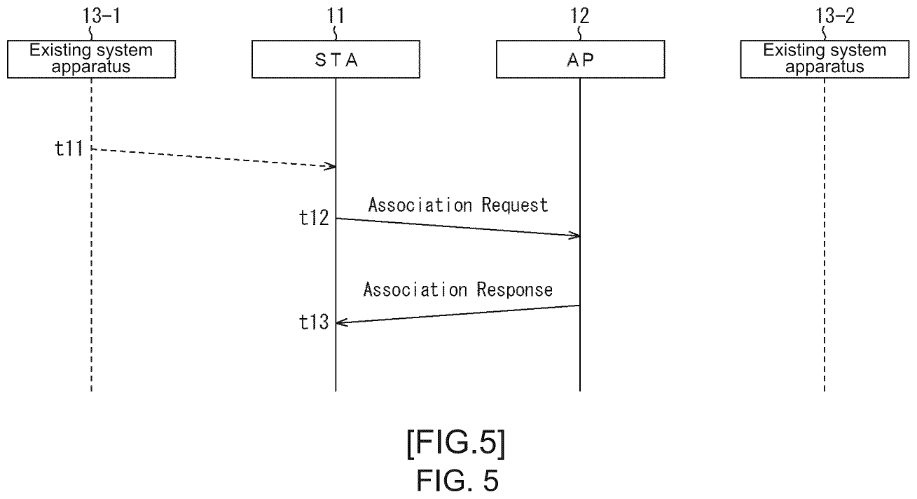

FIG. 5 is a diagram showing a second sequence for the setup of the detection report parameter.

As in the case of FIG. 4, FIG. 5 shows a second sequence in which the STA 11 and the AP 12 exchange the detection report parameter by using a frame exchanged at a timing at which association is executed.

In the case of FIG. 5, the existing system apparatus 13-1 is present around the STA 11, and the STA 11 is in the situation where a reception parameter including an observation value of the existing system signal transmitted from the existing system apparatus 13-1 and the like can be acquired.

For example, at time t11, the existing system apparatus 13-1 transmits the existing system signal. The STA 11 detects the existing system signal.

At time t12, the STA 11 transmits an Association Request frame to a desired AP 12 in order to join the wireless LAN network. At that time, the STA 11 calculates a detection report parameter on the basis of the acquired reception parameter of the existing system signal, adds the calculated detection report parameter to an Association Request frame, and transmits it to the AP 12. The AP 12 receives the Association Request frame.

At time t13, the AP 12 refers to the detection report parameter added to the received Association Request frame, sets each threshold, and transmits an Association Response frame, to which the detection report parameter calculated on the basis of the set thresholds has been added, to the STA 11.

Thus, in the STA 11, it is possible to understand the setting status of each threshold of the AP 12 in the wireless LAN network and to set each threshold.

### <Third Sequence for Setup of Detection Report Parameter>

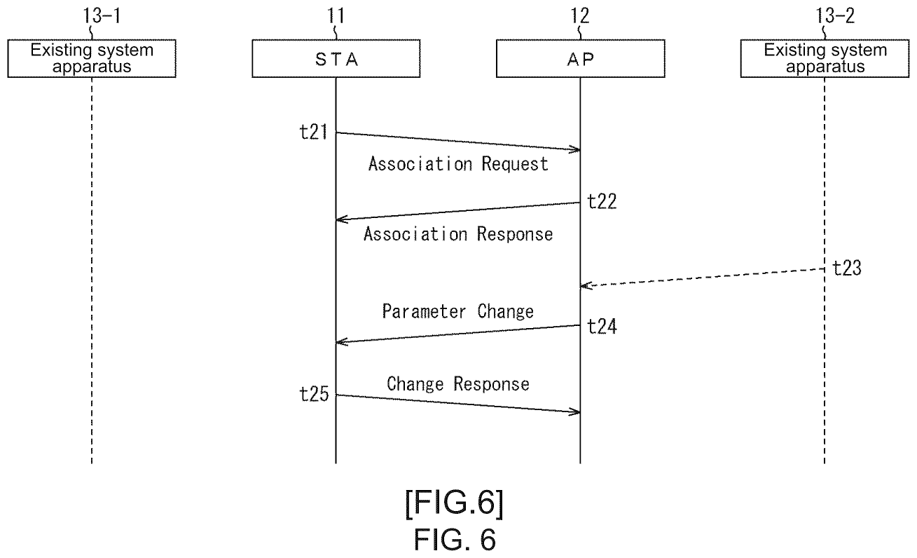

FIG. 6 is a diagram showing a third sequence for the setup of the detection report parameter.

FIG. 6 shows a third sequence in which the STA 11 and the AP 12 exchange the detection report parameter by using a predetermined frame after association.

In the case of FIG. 6, after the association of the STA 11 and the AP 12, the existing system apparatus 13-2 is present around the AP 12, and the AP 12 is in the situation where a reception parameter including an observation value of the signal transmitted from the existing system apparatus 13-2 and the like can be acquired.

At time t21, the STA 11 transmits an Association Request frame to the AP 12 when joining the wireless LAN network. The AP 12 receives the Association Request frame.

At time t22, the AP 12 transmits an Association Response frame to the STA 11 in response to the received Association Request frame and completes the association.

At time t23, the existing system apparatus 13-2 transmits the existing system signal. The AP 12 detects the existing system signal.

The AP 12 refers to the reception parameter of the detected existing system signal, reviews each threshold already set, and if there is a need to change even one of the thresholds, changes the detection report parameter by using any action frame or the like, and notifies the STA 11 of it.

In other words, at time t24, the AP 12 transmits a Parameter Change frame including the changed detection report parameter to the STA 11. The STA 11 receives the Parameter Change frame transmitted from the AP 12.

At time t25, the STA 11 refers to the detection report parameter included in the Parameter Change frame, sets each threshold, and transmits a Change Response frame to the AP 12.

As described above, not only in the association but also after the association, when the state in which the existing system is present around the wireless LAN system is detected or when the AP 12 itself detects a weak signal change, the detection report parameter is recalculated, the Parameter Change frame is transmitted, and each threshold is dynamically changed.

### <First Detection Report Sequence>

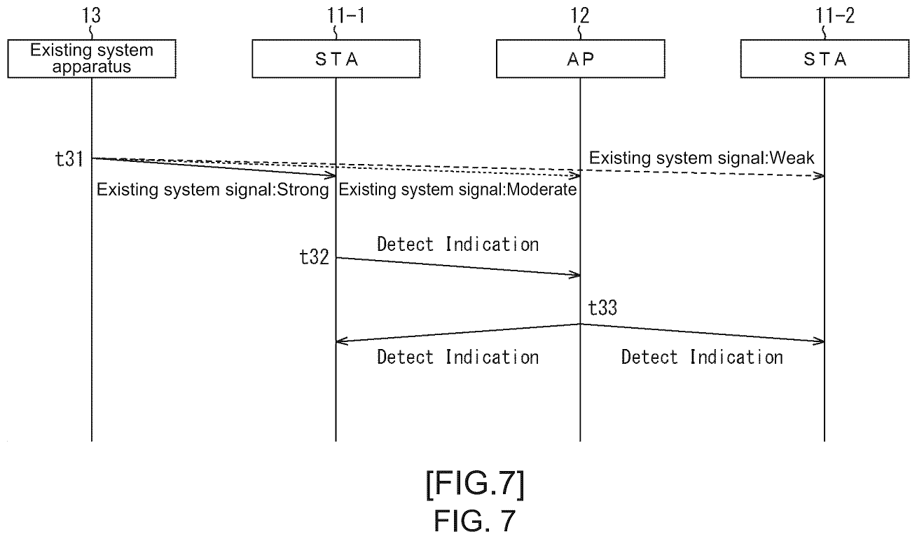

FIG. 7 is a diagram showing a first detection report sequence of the present technology.

FIG. 7 shows a state in which the existing system signal comes from the existing system apparatus 13 located in the vicinity of the wireless LAN system including the STA 11-1, the AP 12, and the STA 11-2.

At time t31, the existing system apparatus 13 transmits the existing system signal. At that time, the STA 11-1 detects the existing system signal at a received electric field strength equal to or larger than the report threshold, as indicated by the arrow of the solid line. The AP 12 detects the existing system signal at a moderate received electric field strength, which is less than the report threshold but can be distinctively detected as signal, as indicated by the arrow of the dotted line. The STA 11-2 detects the existing system signal at a weak received electric field strength, which is enough to detect slight variations in the noise level, as indicated by the arrow of the broken line.

In this case, at time t32, the STA 11-1, which has detected the existing system signal at a received electric field strength exceeding the report threshold, transmits a detection report (Detect Indication) frame for reporting that the existing system signal has been detected. The AP 12 receives the Detect Indication frame.

At time t33, the AP 12 transmits a Detect Indication frame for reporting that the AP 12 has detected the same existing system signal as that detected in the STA 11-1 at a received electric field strength near the detection threshold.

The STA 11-1 receives the transmitted Detect Indication frame. This allows the STA 11-1 to understand that the existing system apparatus 13 is present closer to the STA 11-1 than the AP 12 on the basis of the difference from the observation value of the AP 12.

Further, the STA 11-2 also receives the transmitted Detect Indication frame. This allows the STA 11-2 to understand that the existing system signal from the existing system apparatus 13 located on the side of the STA 11-1 can be detected, although the STA 11-1 is a hidden terminal from the STA 11-2 as described above in FIG. 2.

### <Second Detection Report Sequence>

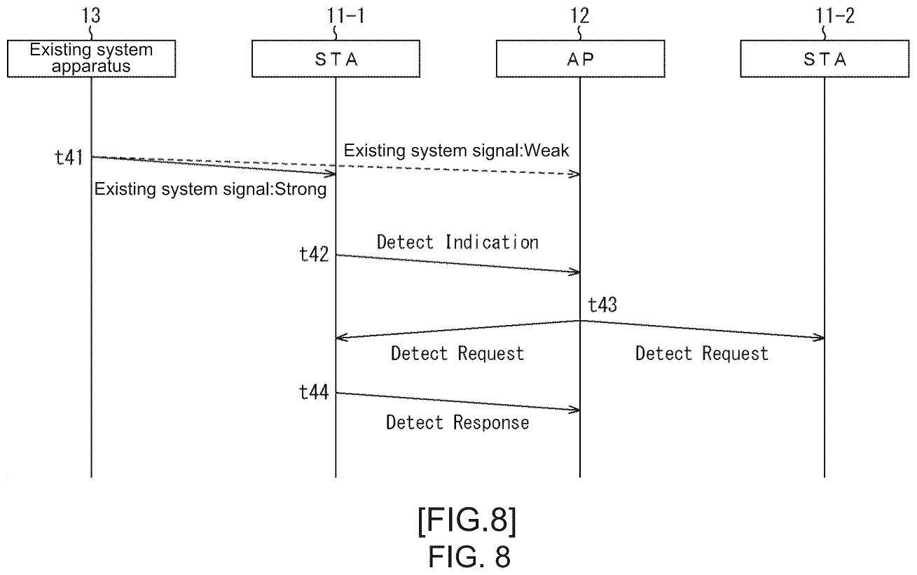

FIG. 8 is a diagram showing a second detection report sequence of the present technology.

FIG. 8 shows a state in which, when the wireless LAN system is disposed as in the case of FIG. 7, the STA 11-1 detects the existing system signal at a received electric field strength exceeding the report threshold.

At time t41, the existing system apparatus 13 transmits the existing system signal. At that time, the STA 11-1 detects the existing system signal at a received electric field strength equal to or larger than the report threshold.

At time t42, the STA 11-1, which has detected the existing system signal at a received electric field strength exceeding the report threshold, transmits a Detect Indication frame for reporting that the existing system signal has been detected. The AP 12 receives the Detect Indication frame.

However, the AP 12 can detect the existing system signal only at a weak received electric field strength, which is enough to detect slight variations in the noise level.

In this case, at time t43, the AP 12 transmits a detection request (Detect Request) frame to the surrounding STAS 11. The STA 11-1 and the STA 11-2 receive the transmitted Detect Request frame.

In other words, there is a possibility that the existing system is present in the vicinity of some STAs 11 of the wireless LAN system, and thus the AP 12 is expected to accurately understand the detection status at any STA 11.

At time t44, the STA 11-1 transmits a Detect Response frame.

Note that the STA 11-1 transmits a Detect Response frame because it has detected the existing system signal at a received electric field strength equal to or larger than the report threshold. It should be noted that, since the STA 11-2 has not detected the existing system signal at a received electric field strength equal to or larger than the report threshold, the STA 11-2 does not transmit a Detect Response frame, but it may also transmit it.

### <Third Detection Report Sequence>

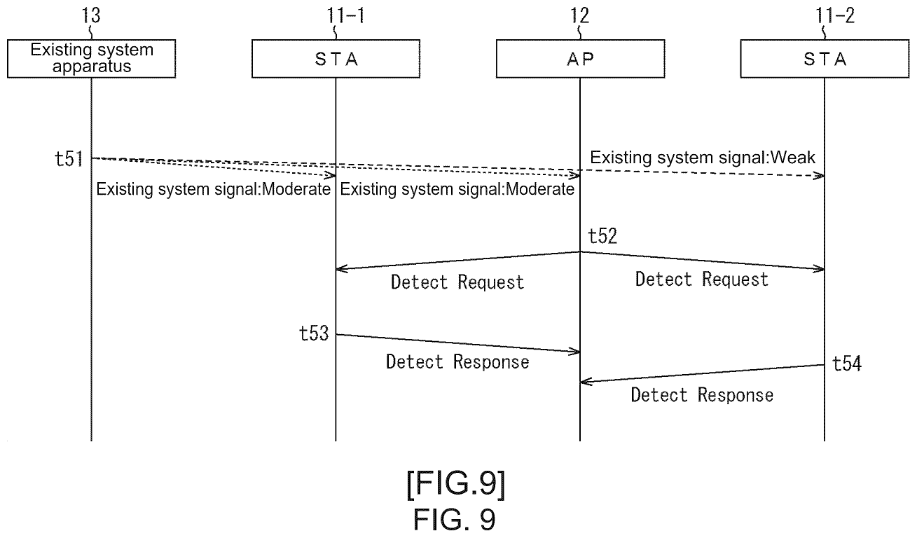

FIG. 9 is a diagram showing a third detection report sequence of the present technology.

FIG. 9 shows a state in which, when the wireless LAN system is disposed as in the case of FIG. 7, the STA 11-1 and the AP 12 detect the existing system signal at a received electric field strength exceeding the detection threshold.

At time t51, the existing system apparatus 13 transmits the existing system signal. At that time, the STA 11-1 and the AP 12 detect the existing system signal at a received electric field strength that is less than the report threshold but exceeds the detection threshold.

At time t52, the AP 12 detects the existing system signal at a received electric field strength that is less than the report threshold, and thus transmits a Report Request frame that requests the surrounding STAS 11 to provide a report just in case. The STAs 11-1 and 11-2 receive the Report Request frame.

At time t53, the STA 11-1 transmits a Detect Response frame to the AP 12 because it has detected the existing system signal at the received electric field strength similar to that of the AP 12.

At time t54, the STA 11-2 has detected the existing signal at a level only slightly above the noise level, but transmits its detection status to the AP 12 as a Detect Response frame. Note that the STA 11-2 may transmit its detection status even if it has not detected any existing system signals.

As described above, in the wireless LAN system, the AP 12 and the STAs 11 report the existing system signal detection statuses in accordance with their detection statuses.

### <Detection Report Parameter Information Element>

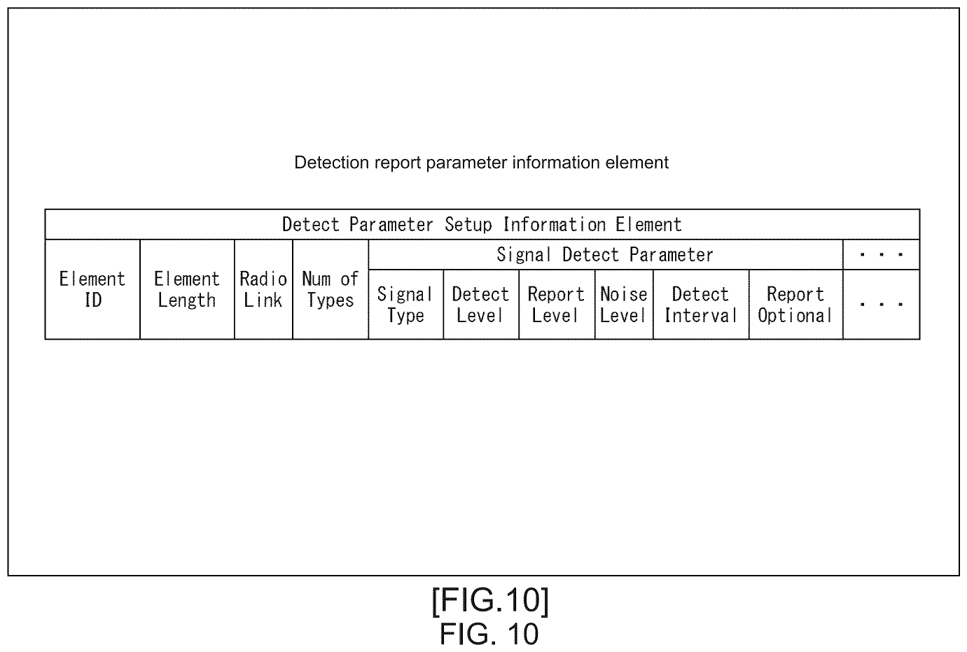

FIG. 10 is a diagram showing a configuration example of a detection report parameter information element (Detect Parameter Setup Information Element).

The information element of FIG. 10 is configured as, for example, a management frame or action frame that is exchanged during association as described above. The information element of FIG. 10 is notified from the STA 11 to the AP 12, for example, by describing information indicating each threshold calculated from the current or past existing system signal detection status and the status of noise level in the Association Request frame as necessary.

The information element is configured to include Element ID, Element Length, Radio Link, Num of Type, and Signal Detect Parameter.

Element ID indicates the format of the information element.

Element Length indicates the length of the information element.

Radio Link indicates a link capable of reporting, for example, via another link (frequency range).

Num of Type indicates the number of signal formats to be detected.

Signal Detect Parameter is the detection report parameter.

Signal Detect Parameter is configured to include Signal Type, Detect Level, Report Level, Detect Interval, Report Optional, and the like.

Signal Type indicates a physical signal format such as a frequency range or a modulation method.

Detect Level indicates the detection threshold described above with reference to FIG. 3.

Report Level indicates the report threshold described above with reference to FIG. 3.

Noise Level indicates the noise level described above with reference to FIG. 3.

Detect Interval indicates a detection period (interval) in which signals are detected.

Report Optional indicates conditions to be reported.

### <Parameter Change Information Element>

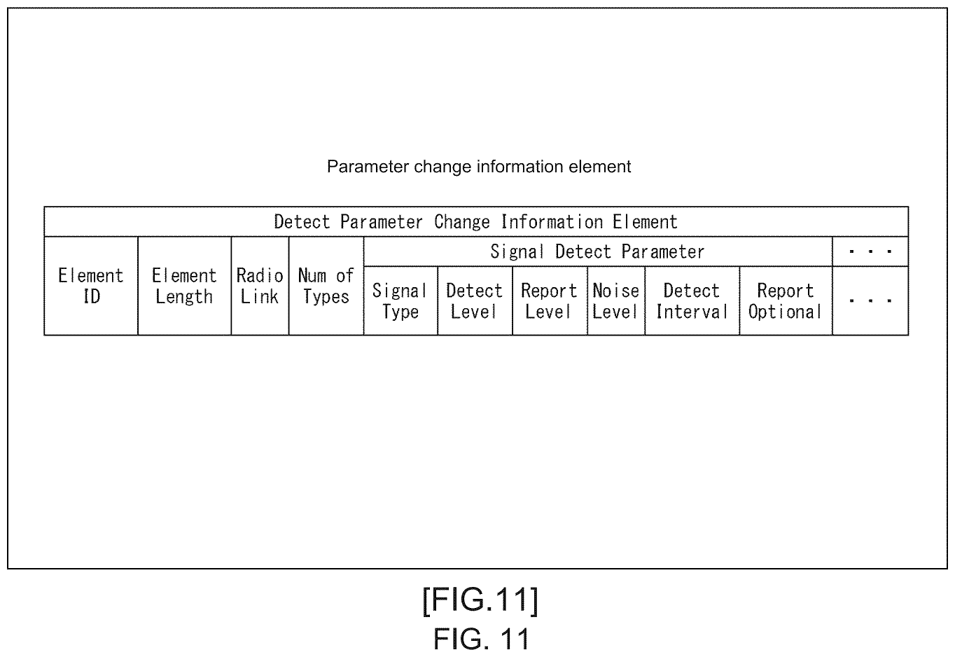

FIG. 11 is a diagram showing a configuration example of a parameter change information element (Detect Parameter Change Information Element).

The information element of FIG. 11 is exchanged, for example, as an element added to a management frame or an action frame at any timing. The information element of FIG. 11 is notified from the AP 12 or the STA 11 by being described as necessary when at least part of the detection report parameter is changed, for example.

Note that the configuration of the information element of FIG. 11 is basically the same as the configuration of the information element of FIG. 10, and thus the description thereof will be omitted.

### <Detect Indication Frame>

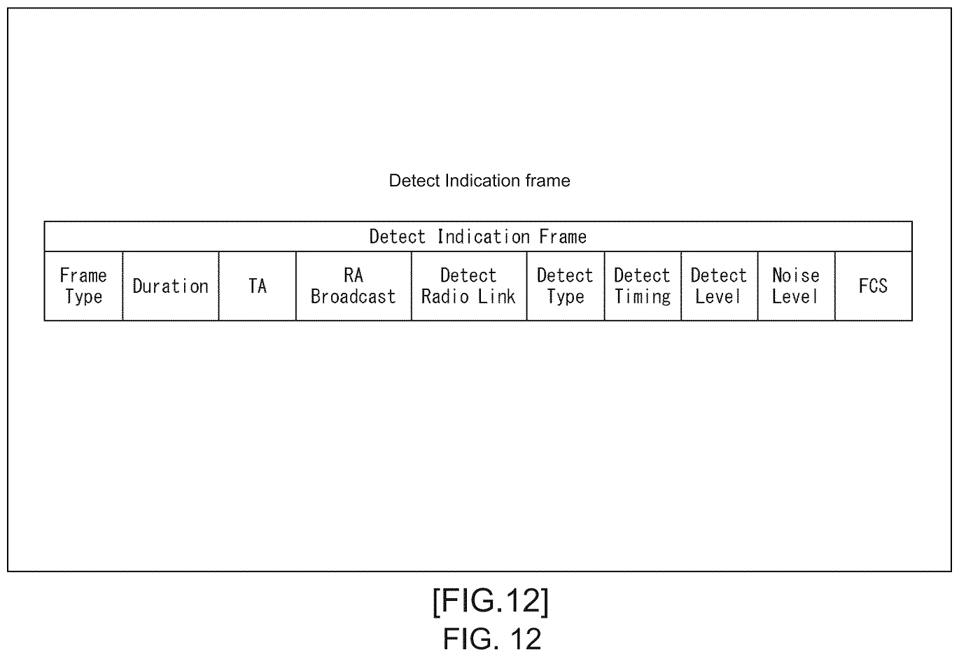

FIG. 12 is a diagram showing a configuration example of the Detect Indication (detection report) frame.

Detect Indication frame can be treated as a general data frame or action frame, but in some cases, it can be treated as a type of control frame and determined so as to provide more reliable reporting.

Detect Indication frame of FIG. 12 is configured to include Frame Type, Duration, TA (Transmit Address), RA (Receive Address) Broadcast, Detect Radio Link, Detect Type, Detect Timing, Detect Level, Noise Level, and frame check sequence (FCS).

Note that Frame Type, Duration, TA, and RA Broadcast have a format corresponding to a predetermined MAC header and are configured as a format compatible with the wireless LAN system. Further, Detect Radio Link, Detect Type, Detect Timing, Detect Level, and Noise Level are parameters to be reported by the Detect Indication frame.

Frame Type indicates the format of the frame.

Duration indicates a duration time of the frame.

TA indicates an address of a communication apparatus on the transmission side.

RA indicates a broadcast address as an address of a communication apparatus on the reception side.

Detect Radio Link indicates a frequency range (radio link) in which the existing system signal has been detected.

Detect Type indicates the type or format of a detection signal that has detected the existing system signal.

Detect Timing indicates the timing at which the existing system signal has been detected.

Detect Level indicates the received electric field strength (detection value) of the existing system signal.

Noise Level indicates the current, stationary noise level.

### <Detect Request Frame>

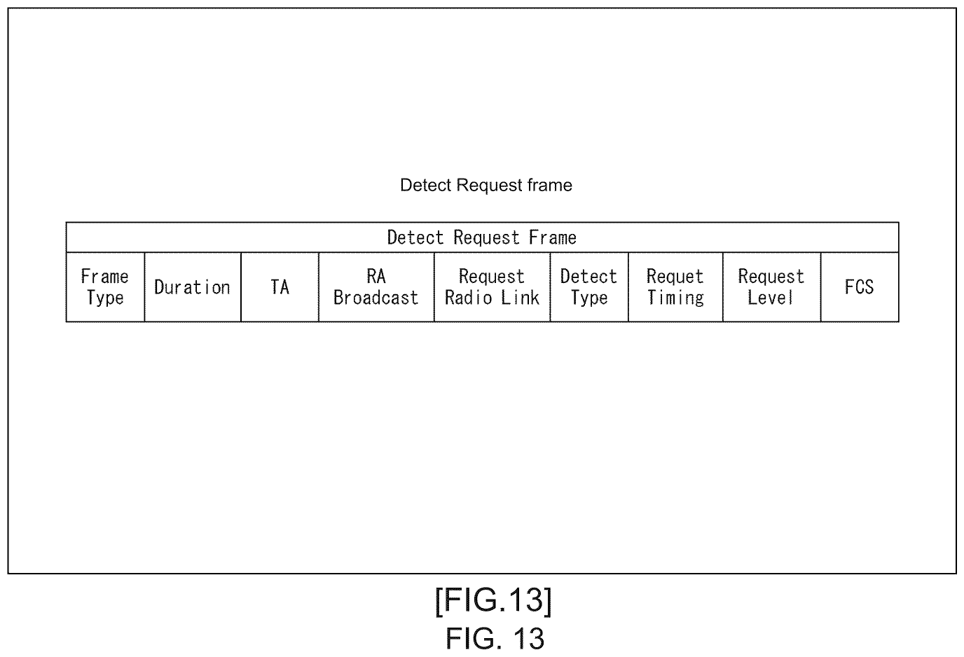

FIG. 13 is a diagram showing a configuration example of the Detect Request (detection request) frame.

Detect Request frame of FIG. 13 is configured to include Frame Type, Duration, TA, RA Broadcast, Request Radio Link, Detect Type, Detect Timing, Detect Level, Noise Level, and FCS.

Note that, similar to Detect Indication frame of FIG. 12, Frame Type, Duration, TA, and RA Broadcast are configured as a format corresponding to a predetermined MAC header and a format compatible with the wireless LAN system. Further, Request Radio Link, Detect Type, Request Timing, and Request Level are parameters requested to be reported by Detect Request frame.

Request Radio Link indicates a frequency range (radio link) in which the reporting of detection is requested.

Detect Type indicates the type or format of a detection signal to be reported.

Request Timing indicates the detection timing at which reporting is requested.

Request Level indicates the received electric field strength that is requested to be reported.

### <Detect Response Frame>

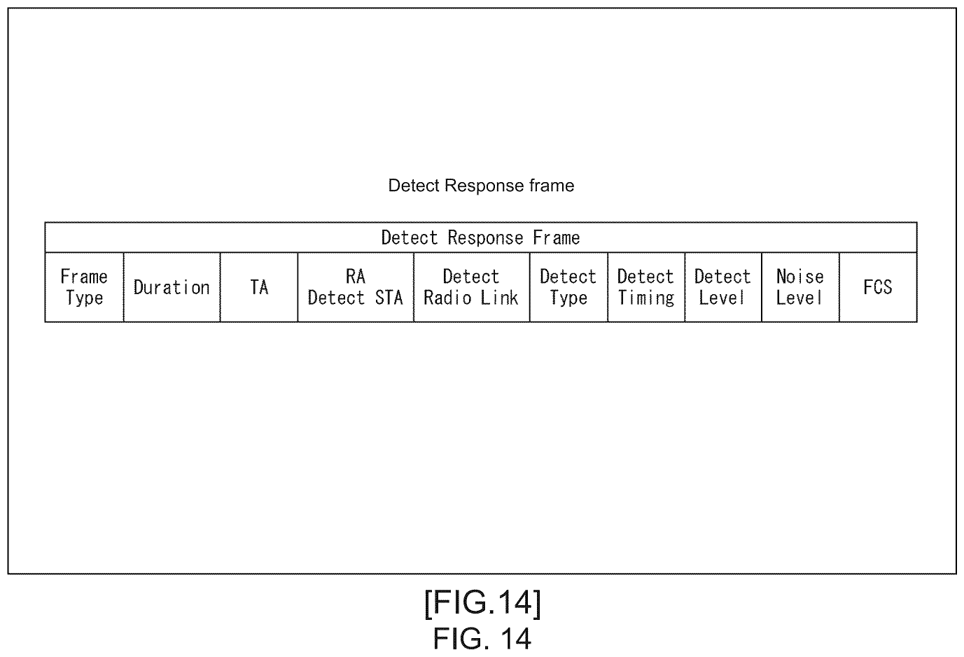

FIG. 14 is a diagram showing a configuration example of the Detect Response (detection response) frame.

Detect Response frame of FIG. 14 is configured to include Frame Type, Duration, TA, RA Detect STA, Request Radio Link, Detect Type, Detect Timing, Detect Level, Noise Level, and FCS.

Note that, similar to Detect Indication frame of FIG. 12, Frame Type, Duration, TA, and RA Detect STA have a format corresponding to a predetermined MAC header and are configured as a format compatible with the wireless LAN system. Further, Detect Radio Link, Detect Type, Detect Timing, Detect Level, and Noise Level are parameters that are responded by the Detect Response frame.

Detect Radio Link, Detect Type, Detect Timing, Detect Level, and Noise Level are different in that the frame in which they are described is Indication or Response, but are the same as those of Detect Indication frame of FIG. 12.

### <Fourth Detection Report Sequence>

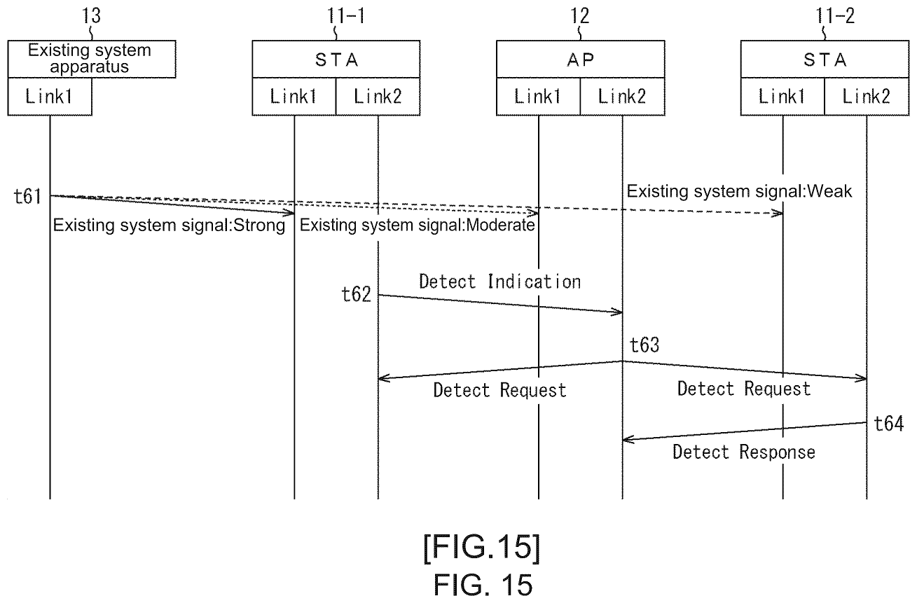

FIG. 15 is a diagram showing a fourth detection report sequence in the multilink case.

FIG. 15 shows, similar to FIG. 7, a state in which the existing system signal comes from the existing system apparatus 13 located in the vicinity of the wireless LAN system including the STA 11-1, the AP 12, and the STA 11-2.

In FIG. 15, the STAs 11-1 and 11-2 and the AP 12 can perform a multilink operation using Link1 and Link2. Note that the Link1 and the Link2 represent two different frequency ranges. The same holds true for a multilink operation using three or more links.

In the case of FIG. 15, it is assumed that the existing system signal is detected in the Link1, which needs to coexist with the existing system, whereas no existing system signal is detected or the frequency bands (5 GHz band, 2.4 GHz band, etc.) that do not need to consider the existing system in the first place are used in the Link2.

In other words, at time t61, the existing system apparatus 13 transmits the existing system signal. At that time, the STA 11-1 detects the existing system signal at a received electric field strength equal to or larger than the report threshold in the Link1. The AP 12 detects the existing system signal at a moderate received electric field strength, which is less than the report threshold but can be distinctively detected as signal, in the Link1. The STA 11-2 detects the existing system signal at a weak received electric field strength, which is enough to detect slight variations in the noise level, in the Link1.

In this case, if a Detect Indication frame is transmitted using the Link1, interference with the existing system may be caused.

Hence, at time t62, the STA 11-1, which has detected the existing system signal at a received electric field strength exceeding the report threshold, transmits a Detect Indication frame using the Link2. At time t63, in order to inquire of the other STA 11 as well about an existing system signal detection status, the AP 12 transmits a Detect Request frame using the Link2. The STA 11-1 and the STA 11-2 receive the Detect Request frame using the Link2.

At time t64, if the Detect Request frame that has been received using the Link2 is a detection request for the Link1, the STA 11-2 transmits a Detect Response frame indicating the existing system signal detection status of the Link1 to the AP 12 by using the Link2.

Note that, if the STA 11-1 has already reported a detection notification of the parameters described in the Detect Request frame received using the Link2, the STA 11-1 can omit transmission of the Detect Response frame. This makes it possible to avoid the overlap of the detection notification and the detection response.

### <Fifth Detection Report Sequence>

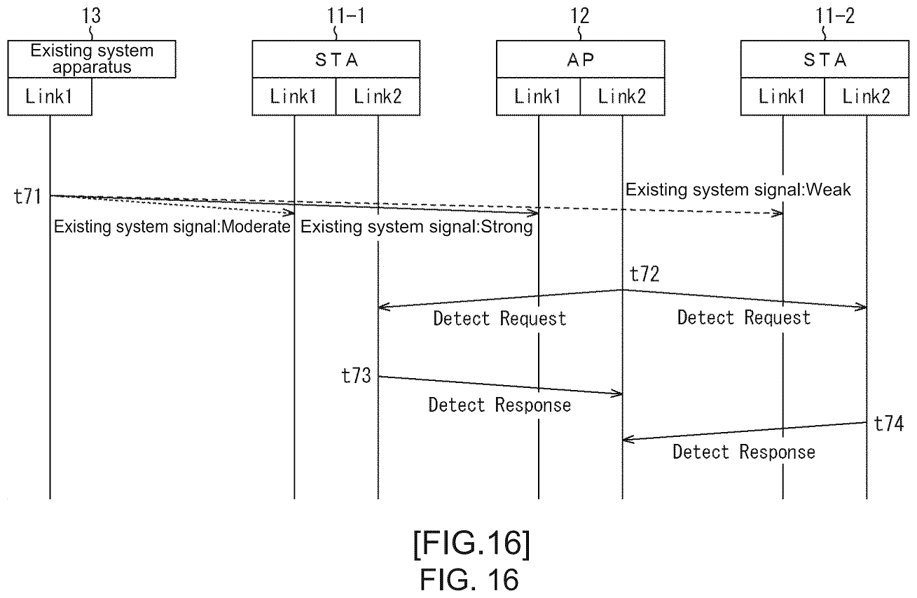

FIG. 16 is a diagram showing a fifth detection report sequence in the case of a multilink operation.

FIG. 16 shows, similar to FIG. 15, a state in which the existing system signal comes from the existing system apparatus 13 located in the vicinity of the wireless LAN system including the STA 11-1, the AP 12, and the STA 11-2 and capable of performing a multilink operation.

At time t71, the existing system apparatus 13 transmits the existing system signal. At that time, the STA 11-1 detects the existing system signal at a moderate received electric field strength, which is less than the report threshold but can be distinctively detected as signal, in the Link1. The AP 12 detects the existing system signal at a received electric field strength equal to or larger than the report threshold in the Link1. The STA 11-2 detects the existing system signal at a weak received electric field strength, which is enough to detect slight variations in the noise level, in the Link1.

In this case, similar to FIG. 15, if a Detect Request frame is transmitted using the Link1, interference with the existing system may be caused.

Hence, at time t72, the AP 12, which has detected the existing system signal at a received electric field strength exceeding the report threshold, transmits a Detect Request frame using the Link2. The STA 11-1 and the STA 11-2 receive the Detect Request frame using the Link2.

At time t73, if the Detect Request frame received using the Link2 is a detection request for the Link1, the STA 11-1 transmits a Detect Response frame indicating the existing system signal detection status of the Link1 to the AP 12 by using the Link2.

At time t74, if the Detect Request frame received using the Link2 is a detection request for the Link1, the STA 11-2 transmits a Detect Response frame indicating the existing system signal detection status of the Link1 to the AP 12 by using the Link2.

As described above, in the case of performing a multilink operation, the information of the link that causes interference (e.g., Link1) can be notified using the link that does not cause interference (e.g., Link2).

Further, as will be described later, when the detection report frame and the detection response frame are exchanged using other links in the multilink operation, those sequences may be used.

### <Sixth Detection Report Sequence>

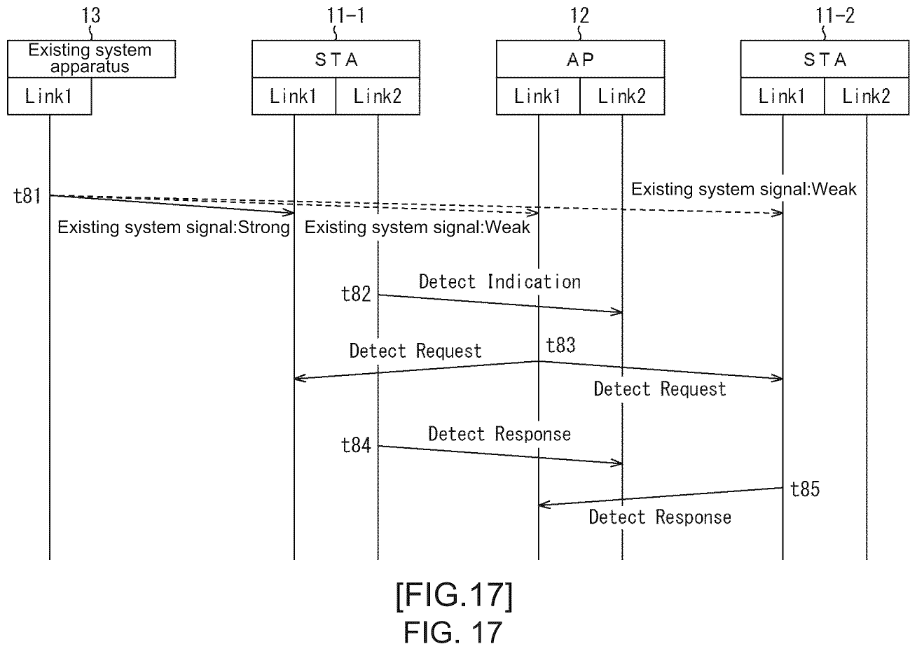

FIG. 17 is a diagram showing a sixth detection report sequence in the case of a multilink operation.

FIG. 17 shows, similar to FIG. 15, a state in which the existing system signal comes from the existing system apparatus 13 located in the vicinity of the wireless LAN system including the STA 11-1, the AP 12, and the STA 11-2 and capable of performing a multilink operation.

At time t81, the existing system apparatus 13 transmits the existing system signal. At that time, the STA 11-1 detects the existing system signal at a received electric field strength equal to or larger than the report threshold in the Link1. The AP 12 and the STA 11-2 detect the existing system signal at a weak received electric field strength, which is enough to detect slight variations in the noise level, in the Link1.

In this case, at time t82, the STA 11-1, which has received the existing system signal at a received electric field strength equal to or larger than the report threshold in the Link1, transmits a Detect Indication frame to the AP 12 using the Link2.

At that time, the AP 12 has not received signals definitely from the existing system in the Link1, and thus determines that the operation can also be performed in the Link1.

Hence, at time t83, the AP 12 transmits a Detect Request frame to the other communication apparatuses (STA 11-1, STA 11-2) of the wireless LAN system by using the Link1.

At time t84, if the STA 11-1 is detecting signals at a predetermined level or higher from the existing system by using the Link1 when receiving the Detect Request frame by using the Link1, there is a possibility that interference may be caused when a response is transmitted using the Link1, so that the STA 11-1 transmits a Detect Response frame to the AP 12 by using the Link2 that has less impact.

At time t85, upon reception of the Detect Request frame by using the Link1, the STA 11-2 can respond about the signal detection status from the existing system in the Link1 by using the Link1 that has less impact, and thus transmits a Detect Response frame to the AP 12 by using the Link1.

As described above, it is possible to perform the multilink operation of selecting a link that has no impact and returning a response in accordance with the signal detection status from the existing system.

Note that the primary system has been described as an example of the existing system in the above description, but actually, the existing system can be, in addition to the primary system, a global positioning system (global navigation satellite system: GNSS), a public communication system, or an independent near field communication system. The AP 12 and the STA 11 can detect or distinguish each existing system by the format of signals. Therefore, the detection threshold, the report threshold, and the like may be set for each type of existing systems.

### 3. Configuration of Wireless Communication Apparatus

### <Configuration of Wireless Communication Apparatus>

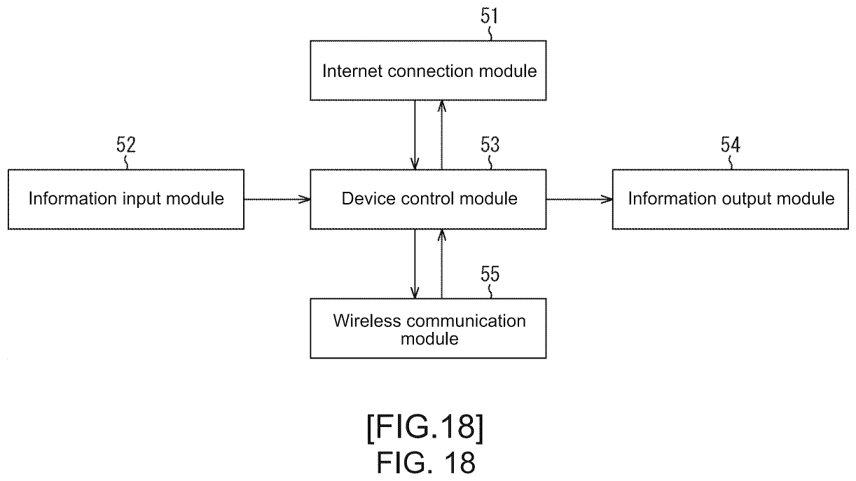

FIG. 18 is a block diagram showing a configuration example of the wireless communication apparatus that operates as the STA 11 or the AP 12.

The wireless communication apparatus of FIG. 18 includes an Internet connection module 51, an information input module 52, a device control module 53, an information output module 54, and a wireless communication module 55.

Note that the wireless communication apparatus may include only the modules to be required.

The Internet connection module 51 is configured to implement functions such as a communication modem for connecting to the Internet network when operating as the AP 12 in accordance with the control of the device control module 53. The Internet connection module 51 connects to the Internet via a public communication line and an Internet service provider.

The information input module 52 outputs the information for giving an instruction input by the user to the device control module 53. The information input module 52 includes a push button, a keyboard, a touch panel, and the like.

The device control module 53 includes a central processing unit (CPU), a read only memory (ROM), a random access memory (RAM), and the like. The device control module 53 executes a program stored in the ROM or the like, causes an application to function at a higher-level layer, and controls the wireless communication apparatus to operate as the STA 11 or the AP 12.

The information output module 54 outputs information relating to the operating state of the wireless communication apparatus, which is supplied from the device control module 53, or information obtained via the Internet. The information output module 54 includes a display device such as an LED, a liquid crystal panel, or an organic display, or a speaker that outputs sound and music. The information output module 54 performs display or notification of the information that the user needs.

The wireless communication module 55 performs wireless communication to transmit the data, which is supplied from the device control module 53, to another wireless communication apparatus. The wireless communication module 55 performs wireless communication to receive the data transmitted from another wireless communication apparatus and output the received data to the device control module 53.

### <Configuration of Wireless Communication Module>

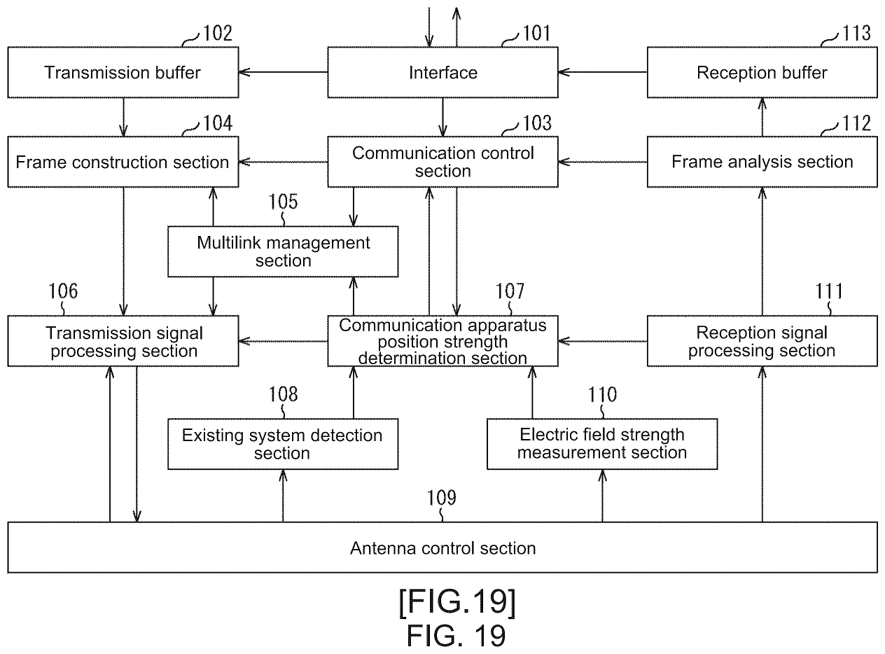

FIG. 19 is a block diagram showing a configuration example of the wireless communication module 55.

The wireless communication module 55 includes an interface 101, a transmission buffer 102, a communication control section 103, a frame construction section 104, a multilink management section 105, a transmission signal processing section 106, and a communication apparatus position strength determination section 107. Further, the wireless communication module 55 includes an existing system detection section 108, an antenna control section 109, an electric field strength measurement section 110, a reception signal processing section 111, a frame analysis section 112, and a reception buffer 113.

The interface 101 functions as an interface for exchanging the information input by the user or the data supplied from the Internet network in a predetermined signal format, with the device control module 53.

The interface 101 outputs the information or data supplied from the device control module 53 to the transmission buffer 102 and the communication control section 103. The interface 101 outputs the information or data supplied from the reception buffer 113 to the device control module 53.

When receiving the information input by the user or the signals for performing wireless communication, the transmission buffer 102 temporarily stores the received signals.

The communication control section 103 manages the operation for transmitting and receiving data and parameters on the basis of the information supplied from the interface 101 and the frame analysis section 112. The communication control section 103 grasps the construction of frames and the state of transmitted or received data, and controls the frame construction section 104, the multilink management section 105, and the communication apparatus position strength determination section 107.

The frame construction section 104 constructs, for example, a frame for setting the detection report parameter or the detection report frame by using the data stored in the transmission buffer 102 and the parameters supplied from the communication control section 103, in accordance with the instruction of the communication control section 103. The frame construction section 104 outputs the constructed frame to the transmission signal processing section 106.

The multilink management section 105 manages the frequency range (radio link) available for the multilink operation on the basis of the result of the determination on the received electric field strength of the existing system signal and the result of the determination on the position of the communication apparatus, which are supplied from the communication apparatus position strength determination section 107, in accordance with the instruction of the communication control section 103.

The transmission signal processing section 106 performs encoding processing on the data configuring the frame supplied from the frame construction section 104 by using the result of the determination on the received electric field strength of the existing system signal by the communication apparatus position strength determination section 107 and the result of the determination by the existing system detection section 108, and converts the encoded data into radio signals to be output to the antenna control section 109.

The communication apparatus position strength determination section 107 sets each threshold of the received electric field strength on the basis of the information such as parameters obtained from received frames supplied from the communication control section 103, the reception signal processing section 111, etc.

The communication apparatus position strength determination section 107 determines the received electric field strength of the existing system signal and the relative positions of the communication apparatuses (the STA 11 and the AP 12) on the basis of the determination result of the existing system signal supplied from the existing system detection section 108, the measurement result of the received electric field strength supplied from the electric field strength measurement section 110, and each set threshold.

Further, the communication apparatus position strength determination section 107 outputs the determination result of the position of the communication apparatus and the strength of the received electric field strength to the communication control section 103, the multilink management section 105, the transmission signal processing section 106, etc.

The existing system detection section 108 is configured to include a circuit for detecting signals from the existing system by using impulses. The existing system detection section 108 determines whether or not the signal detected by the antenna control section 109 and supplied from the antenna control section 109 is an existing system signal, and outputs the determination result of the existing system signal to the communication apparatus position strength determination section 107.

The antenna control section 109 transmits the signal supplied from the transmission signal processing section 106 to the STA 11 or the AP 12 as a communication partner. The antenna control section 109 detects (receives) the signal transmitted from the STA 11 or the AP 12 as a communication partner and outputs the detected signal to the reception signal processing section 111.

The electric field strength measurement section 110 measures the received electric field strength of the signal supplied from the antenna control section 109 and outputs the measurement result to the communication apparatus position strength determination section 107.

The reception signal processing section 111 decodes the signal supplied from the antenna control section 109 and outputs the resultant signal to the frame analysis section 112.

The frame analysis section 112 extracts a predetermined data frame or parameters from the received data. The frame analysis section 112 outputs the extracted information to the communication control section 103 and outputs the extracted data to the reception buffer 113.

The reception buffer 113 stores the data supplied from the frame analysis section 112.

### 4. Operation of Wireless Communication Apparatus

### <Processing of STA 11>

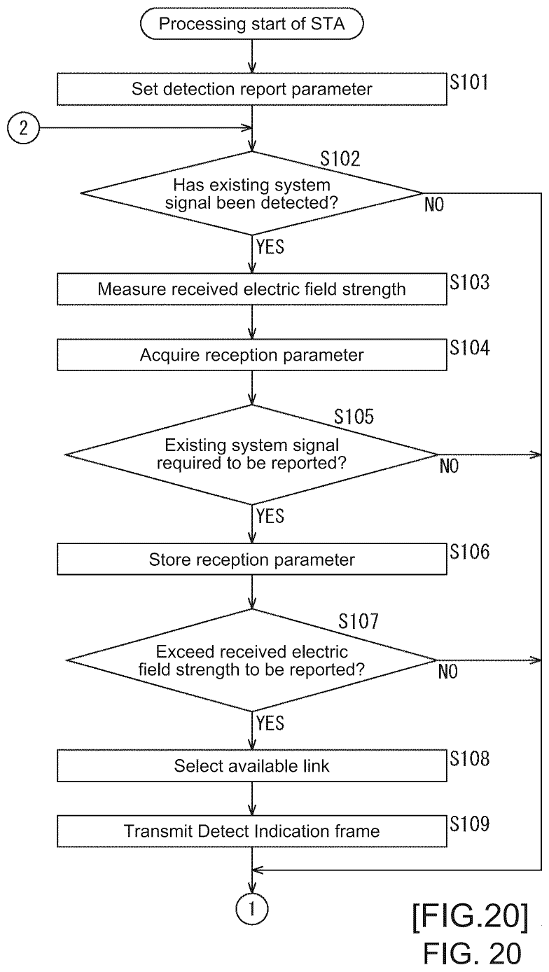

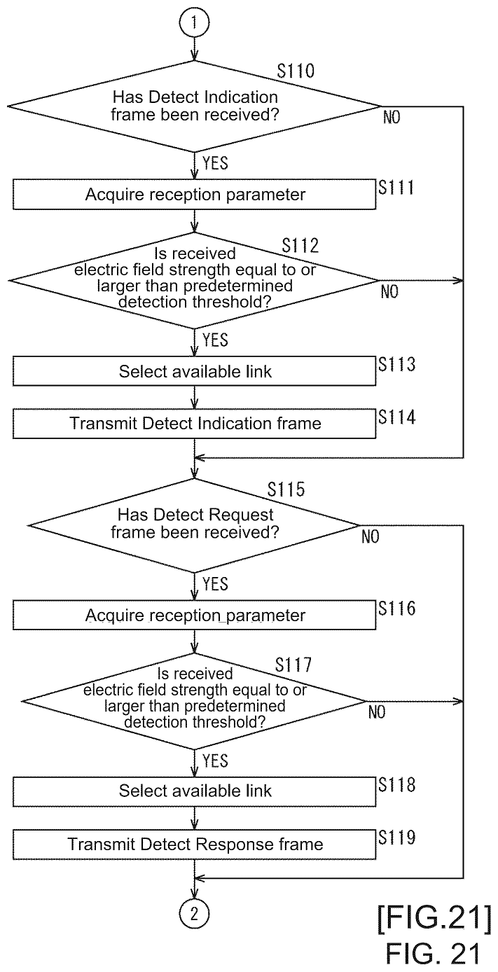

FIGS. 20 and 21 are flowcharts for describing the processing of the STA 11.

Note that this processing is executed by the communication control section 103, of the wireless communication apparatus (FIG. 19) that operates as the STA 11, controlling each section.

In Step S101, the communication control section 103 of the STA 11 exchanges frames including the above-mentioned detection report parameter with the AP12, for example, at the timing of performing association, and the communication apparatus position strength determination section 107 sets the thresholds and the like on the basis of the detection report parameter and the past existing system signal detection status.

In Step S102, the existing system detection section 108 determines whether or not the existing system signal has been detected. If the signal detected by and supplied from the antenna control section 109 is the existing system signal, it is determined that the existing system signal has been detected, and the processing proceeds to Step S103.

In Step S103, the electric field strength measurement section 110 measures the received electric field strength of the detected existing system signal.

In Step S104, the communication control section 103 acquires the reception parameter (detection timing, signal format, detection value of received electric field strength, etc.) of the detected existing system signal.

In Step S105, the communication apparatus position strength determination section 107 determines whether or not the existing system signal is required to be reported on the basis of the acquired signal format. If it is determined in Step S105 that the existing system signal is required to be reported, the processing proceeds to Step S106.

In Step S106, the communication control section 103 stores the acquired reception parameter.

Note that, for example, in the case where only the primary system is required to be reported, there are signals other than the existing system signals required to be reported, and even in the existing system signals not required to be reported, the reception parameters thereof may be stored and reported as necessary.

In Step S107, the communication apparatus position strength determination section 107 determines whether or not the received electric field strength to be reported (e.g., report threshold) is exceeded on the basis of the measured received electric field strength. The received electric field strength to be reported may be a detection threshold or a noise level value. If it is determined in Step S107 that the received electric field strength to be reported is exceeded, the processing proceeds to Step S108.

If a multilink operation is being performed, in Step S108, the multilink management section 105 selects an available link. Note that if the multilink operation is not being performed, the processing of Step S108 is skipped.

In Step S109, the communication control section 103 transmits a Detect Indication frame to a surrounding communication apparatus. The processing then proceeds to Step S110 of FIG. 21.

Further, if it is determined in Step S102 that the existing system signal has not been detected, if it is determined in Step S105 that the existing system signal is not required to be reported, or if it is determined in Step S107 that the received electric field strength to be reported is not exceeded, the processing proceeds to Step S110 of FIG. 21.

In Step S110, the communication control section 103 determines whether or not a Detect Indication frame has been received. If it is determined in Step S110 that a Detect Indication frame has been received, the processing proceeds to Step S111.

In Step S111, the communication control section 103 acquires the reception parameter of the existing system signal, which is described in the received Detect Indication frame.

In Step S112, the communication apparatus position strength determination section 107 determines whether or not the received electric field strength of the signal detected at the detection timing of the existing system signal described in the received Detect Indication frame is equal to or larger than a predetermined detection threshold, for example, exceeds the detection threshold. Note that the predetermined detection threshold may be the report threshold or the noise level value on the basis of the surrounding detection status.

If it is determined in Step S112 that the received electric field strength is equal to or larger than a predetermined detection threshold, the processing proceeds to Step S113.

If a multilink operation is being performed, in Step S113, the multilink management section 105 selects an available link. Note that if the multilink operation is not being performed, the processing of Step S113 is skipped.

In Step S114, the communication control section 103 transmits a Detect Indication frame to a surrounding communication apparatus. The processing then proceeds to Step S115.

Further, if it is determined in Step S110 that the Detect Indication frame has not been detected, or if it is determined in Step S113 that the received electric field strength is less than the predetermined detection threshold, the processing proceeds to Step S115.

In Step S115, the communication control section 103 determines whether or not a Detect Request frame has been received. If it is determined in Step S115 that a Detect Request frame has been received, the processing proceeds to Step S116.

In Step S116, the communication control section 103 acquires the reception parameter of the existing system signal described in the received Detect Request frame.

In Step S117, the communication apparatus position strength determination section 107 determines whether or not the received electric field strength of the signal detected at the detection timing of the existing system signal described in the received Detect Request frame is equal to or larger than a predetermined detection threshold, for example, exceeds the detection threshold. Note that the predetermined detection threshold may be the report threshold or the noise level value on the basis of the surrounding detection status.

If it is determined in Step S117 that the received electric field strength is equal to or larger than a predetermined detection threshold, the processing proceeds to Step S118.

If a multilink operation is being performed, in Step S118, the multilink management section 105 selects an available link. Note that if the multilink operation is not being performed, the processing of Step S118 is skipped.

In Step S119, the communication control section 103 transmits a Detect Response frame to a surrounding communication apparatus. The processing then returns to Step S102 of FIG. 20, and the subsequent processing is repeated.

If the communication control section 103 determines in Step S115 that a Detect Request frame has not been received or if it is determined in Step S117 that the received electric field strength is less than a predetermined detection threshold, the processing returns to Step S102 of FIG. 20, and the subsequent processing is repeated.

### <Processing of AP 12>

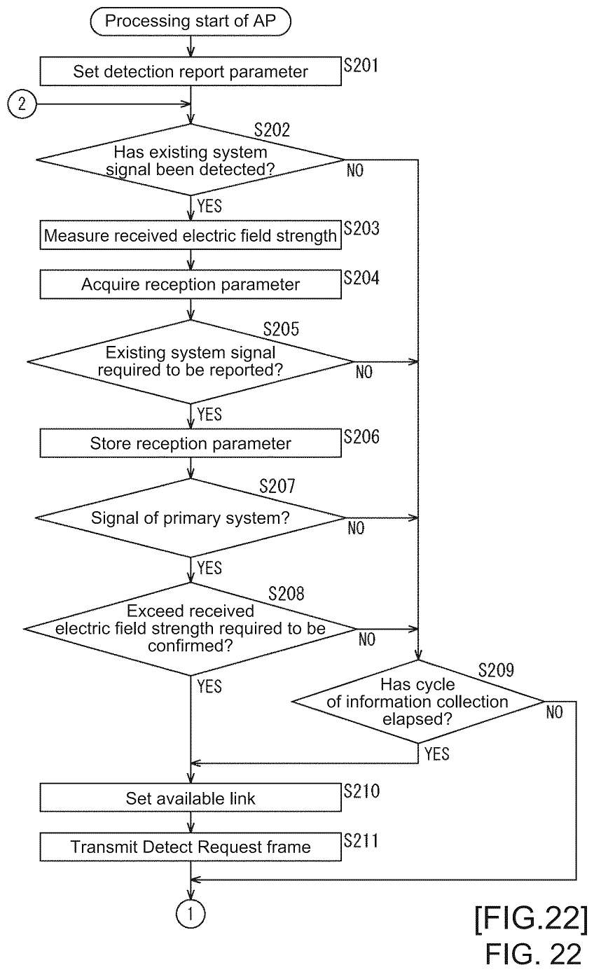

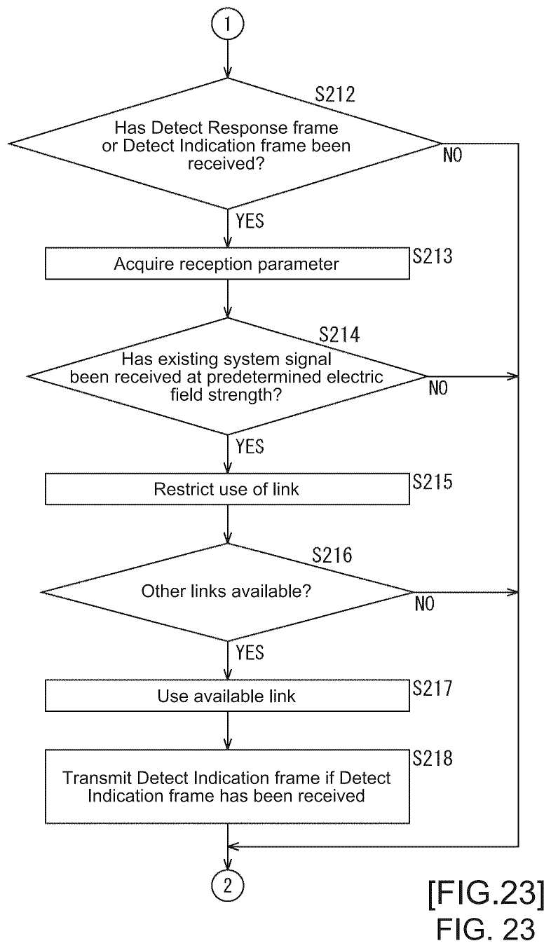

FIGS. 22 and 23 are flowcharts for describing the processing of the AP 12.

Note that this processing is executed by the communication control section 103, of the wireless communication apparatus (FIG. 19) that operates as the AP 12, controlling each section.

The processing from Steps S201 to S206 are similar to the processing from Steps S101 to S106 of FIG. 20, except that the STA 11 is replaced with the AP 12, and thus the description thereof will be omitted.

In Step S207, the communication control section 103 determines whether or not the existing system signal is a signal of the primary system among the existing system signals on the basis of the signal format of the detected existing system signal. If it is determined that the existing system signal is a signal of the primary system, the processing proceeds to Step S208.

In Step S208, the communication apparatus position strength determination section 107 determines whether or not the received electric field strength required to be confirmed (e.g., detection threshold) is exceeded on the basis of the received electric field strength measured by the electric field strength measurement section 110. The received electric field strength required to be confirmed may be the report threshold or the noise level value. If it is determined in Step S208 that the received electric field strength required to be confirmed is not exceeded, the processing proceeds to Step S209.

If it is determined in Step S207 that the existing system signal is not a signal of the primary system, the processing proceeds to Step S209.

In Step S209, the communication control section 103 determines whether or not the preset cycle of information collection has elapsed. If it is determined in Step S209 that the preset cycle of information collection has elapsed, the processing proceeds to Step S210.

If it is determined in Step S208 that the received electric field strength required to be confirmed is exceeded, the processing proceeds to Step S210.

If a multilink operation is being performed, in Step S210, the multilink management section 105 selects an available link. Note that if the multilink operation is not being performed, the processing of Step S210 is skipped.

In Step S211, the communication control section 103 transmits a Detect Request frame to a surrounding communication apparatus. The processing then proceeds to Step S212 of FIG. 23.

If it is determined in Step S209 that the preset cycle of information collection has not elapsed, the processing proceeds to Step S212 of FIG. 23.

In Step S212, the communication control section 103 determines whether or not a Detect Response frame or Detect Indication frame has been received. If it is determined in Step S212 that a Detect Response frame or Detect Indication frame has been received, the processing proceeds to Step S213.

In Step S213, the communication control section 103 acquires the reception parameter of the existing system signal described in the received Detect Response frame or Detect Indication frame.

In Step S214, the communication apparatus position strength determination section 107 determines whether or not the existing system signal has been detected at a predetermined received electric field strength (e.g., detection threshold or larger). The predetermined received electric field strength may be the report threshold or the noise level value. If it is determined in Step S214 that the existing system signal has been detected at a predetermined received electric field strength, the processing proceeds to Step S215.

In Step S215, the multilink management section 105 restricts the use of the link in which the existing system signal described in the acquired reception parameter has been received.

In Step S216, the multilink management section 105 determines whether or not other links are available. If no existing system signals are detected and it is determined in Step S216 that other links are available, the processing proceeds to Step S217.

In Step S217, the multilink management section 105 uses an available link.

In Step S218, if the frame determined to have been received in Step S212 is a Detect Indication frame, the communication control section 103 transmits a Detect Indication frame to another surrounding communication apparatus. If the frame determined to have been received in Step S212 is a Detect Response frame, Step S218 is skipped. The processing then returns to Step S202 of FIG. 22, and the subsequent processing is repeated.

If it is determined in Step S213 that a Detect Response frame or Detect Indication frame has not been received, or if it is determined in Step S214 that no existing system signal is detected at a predetermined received electric field strength, the processing returns to Step S202 of FIG. 22, and the subsequent processing is repeated.

If it is determined in Step S216 that other links are not available, the processing returns to Step S202 of FIG. 22, and the subsequent processing is repeated.

As described above, when signals are detected in the frequency bands in which a wireless LAN system is operated in coexistence with an existing system including the primary system, the existing system is detected, so that the wireless LAN system can be operated without affecting the existing system.

The signal detection result of the existing system is reported in accordance with a predetermined report threshold set in advance, so that a redundant detection report can be limited, thereby reducing interference with the existing system.

Furthermore, the primary system is identified and detected from the signal format, so that the wireless LAN system can be operated without affecting the primary system.

When a system signal other than the signal format of the primary system is detected as an existing system signal, the wireless LAN network can also be operated without suppressing signal transmission more than necessary.

In particular, signals from a communication apparatus in the wireless LAN system within a range that does not affect signals from the existing system can be received without affecting the existing system at all.

Grasping the detection status of a surrounding communication apparatus in the wireless LAN system makes it possible to grasp the relative positions within the network and optimize the operation form so as not affect the existing system.

The signal format of the detected signal is identified and distinguished from those of other existing systems, so that a method of limiting the operation only when a signal of the primary system is detected can be obtained.

The report threshold for reporting and the detection threshold for detection (e.g., only storing reception parameter) are set on the basis of the noise level value and then observed, so that characteristics of the existing system signal can be effectively understood.

In particular, setting a threshold level for transmitting reports can avoid transmitting and receiving reports more than necessary and can cause less interference with the existing system.

In a multilink-supporting wireless communication apparatus, a method of using, when existing system signals are detected in a certain link, other links to notify these statuses can be obtained.

### 5. Others

### <Effects>

As described above, in the present technology, thresholds of a plurality of levels are set for the received electric field strength of the detected signal, the detected signal is detected to be an existing system signal of a predetermined existing system, and the received electric field strength of the existing system signal is measured. If the measured received electric field strength exceeds a threshold of the predetermined existing system among the thresholds of the plurality of levels, a predetermined signal is transmitted to another surrounding wireless communication apparatus.

This makes it possible to operate the wireless LAN system without affecting the existing communication system.

### <Configuration Example of Computer>

The series of processing described above can be executed by hardware or can also be executed by software. If the series of processing is executed by software, a program that configures the software is installed on a computer incorporated into dedicated hardware, a general-purpose personal computer, or the like from a program recording medium.

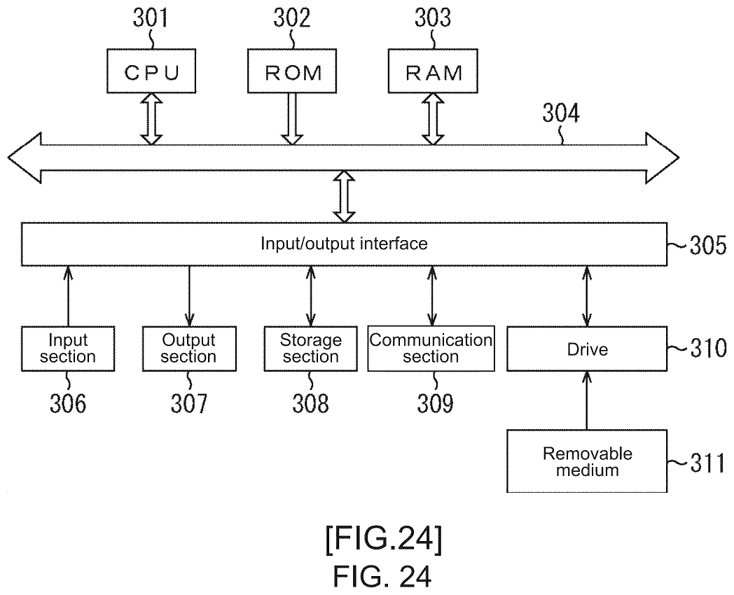

FIG. 24 is a block diagram showing a hardware configuration example of a computer that executes the series of processing described above with a program.

A central processing unit (CPU) 301, a read only memory (ROM) 302, and a random access memory (RAM) 303 are mutually connected by a bus 304.

In addition, an input/output interface 305 is connected to the bus 304. An input section 306 including a keyboard, a mouse, and the like, and an output section 307 including a display, a speaker, and the like are connected to the input/output interface 305. Further, a storage section 308 including a hard disk, a nonvolatile memory, and the like, a communication section 309 including a network interface and the like, and a drive 310 that drives a removable medium 311 are connected to the input/output interface 305.

In the computer configured as described above, the series of processing described above is performed by the CPU 301, for example, loading a program stored in the storage section 308 to the RAM 303 via the input/output interface 305 and the bus 304 and executing the program.

Programs to be executed by the CPU 301 can be provided, for example, by being recorded on the removable medium 311 or provided via a wired or wireless transmission medium such as a local area network, the Internet, or digital satellite broadcasting to be installed on the storage section 308.

Note that the programs to be executed by the computer may be programs that are processed chronologically according to the order described herein, or may be programs that are processed in parallel or at the necessary timing, such as when a call is made.

Note that, in this specification, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

Further, the effects described herein are merely exemplary ones and are not restrictive ones, and any other effects may be produced.

The embodiments of the present technology are not limited to the embodiments described above, and can be variously modified without departing from the spirit of the present technology.

For example, the present technology can have a configuration of cloud computing in which a single function is shared and cooperatively processed by a plurality of apparatuses through a network.

Further, the steps described in the flowcharts described above can be executed by one apparatus or shared and executed by a plurality of apparatuses.

Furthermore, in the case where one step includes a plurality of processing steps, the plurality of processing steps included in the one step can be executed by one apparatus or shared and executed by a plurality of apparatuses.

### <Combination Examples of Configurations>

The present technology can have the following configurations.
(1) A wireless communication apparatus, including:
   a setting section that sets thresholds of a plurality of levels for a received electric field strength of a detected signal;
   a detection section that detects that the detected signal is an existing system signal of a predetermined existing system;
   a measurement section that measures a received electric field strength of the existing system signal; and
   a communication control section that transmits a predetermined signal to another surrounding wireless communication apparatus when the measured received electric field strength exceeds a threshold of the predetermined existing system among the thresholds of the plurality of levels.
(2) The wireless communication apparatus according to (1), in which
   the thresholds of the plurality of levels include at least a detection threshold that is used to determine detection of the existing system signal, and a report threshold that has a larger level than the detection threshold and is used to determine a need to report the detection of the existing system signal.
(3) The wireless communication apparatus according to (1) or (2), in which
   the setting section measures a noise level value from the received electric field strength of the detected signal and sets the thresholds of the plurality of levels on the basis of the noise level value.
(4) The wireless communication apparatus according to (2), in which
   the communication control section transmits a report signal that reports the detection of the existing system signal to the other wireless communication apparatus when the measured received electric field strength exceeds the report threshold.
(5) The wireless communication apparatus according to (4), in which
   the communication control section transmits the report signal that includes at least a signal format of the existing system signal, a detection timing, and a detection value of the received electric field strength.
(6) The wireless communication apparatus according to (4), in which
   the communication control section transmits a response signal for a request signal when the request signal indicating a report request transmitted from the other wireless communication apparatus is received.
(7) The wireless communication apparatus according to (6), in which
   the communication control section transmits the response signal that includes at least a signal format of the existing system signal, a detection timing, and a detection value of the received electric field strength.
(8) The wireless communication apparatus according to (2), in which
   the communication control section transmits a request signal indicating a report request to the other wireless communication apparatus when the measured received electric field strength exceeds the detection threshold.
(9) The wireless communication apparatus according to (8), in which
   the communication control section transmits the request signal that includes at least a signal format of the existing system signal to be requested, a detection timing, and a detection value of the received electric field strength.
(10) The wireless communication apparatus according to (8), in Which
   the communication control section transmits the request signal to the other wireless communication apparatus also when a predetermined period of time elapses after the last transmission of the request signal.
(11) The wireless communication apparatus according to (8), in which
   when a report signal that reports detection of the existing system signal transmitted from the other wireless communication apparatus is received, the communication control section transmits the report signal.
(12) The wireless communication apparatus according to (8), in which
   the thresholds of the plurality of levels include a noise level value, and
   when a report signal that reports detection of the existing system signal transmitted from the other wireless communication apparatus is received, and the measured received electric field strength exceeds the noise level value, the communication control section transmits the request signal.
(13) The wireless communication apparatus according to (1), further including
   a multilink management section that manages a plurality of links for performing communication, in which
   the communication control section transmits the predetermined signal to the other wireless communication apparatus by using a link in which the existing system signal is not detected, among the plurality of links.
(14) The wireless communication apparatus according to any one of (1) to (12), in which
   the setting section transmits and receives the thresholds of the plurality of levels to and from the other wireless communication apparatus, to set the thresholds of the plurality of levels.
(15) The wireless communication apparatus according to (14), in which
   the setting section transmits and receives the thresholds of the plurality of levels to and from the other wireless communication apparatus during association, to set the thresholds of the plurality of levels.
(16) The wireless communication apparatus according to (14), in which
   when at least one of the thresholds of the plurality of levels changes, the setting section transmits and receives the thresholds of the plurality of levels to and from the other wireless communication apparatus, to set the thresholds of the plurality of levels.
(17) The wireless communication apparatus according to any one of (1) to (16), further including
   a storage section that stores a signal format of the detected existing system signal, a detection timing, and a detection value of the received electric field strength.
(18) The wireless communication apparatus according to any one of (1) to (17), in which
   the existing system signal is a signal of a primary system, a public communication system, an independent near field communication system, or a global positioning system.
(19) The wireless communication apparatus according to any one of (1) to (18), further including
   a storage section that stores a signal format of the detected existing system signal, a detection timing, and a detection value of the received electric field strength, in which
   when the existing system signal is a signal of the primary system, the communication control section transmits the predetermined signal that includes at least the signal format of the existing system signal, the detection timing, and the detection value of the received electric field strength.
(20) A wireless communication method for a wireless communication apparatus, the wireless communication method including:
   setting thresholds of a plurality of levels for a received electric field strength of a detected signal;
   detecting that the detected signal is an existing system signal of a predetermined existing system;
   measuring a received electric field strength of the existing system signal; and
   transmitting a predetermined signal to another surrounding wireless communication apparatus when the measured received electric field strength exceeds a threshold of the predetermined existing system among the thresholds of the plurality of levels.

### REFERENCE SIGNS LIST

11, 11-1, 11-2 STA
12 AP
13 existing system apparatus
51 Internet connection module
52 information input module
53 device control module
54 information output module
55 wireless communication module
101 interface
102 transmission buffer
103 communication control section
104 frame construction section
105 multilink management section
106 transmission signal processing section
107 communication apparatus position strength determination section
108 existing system detection section
109 antenna control section
110 electric field strength measurement section
111 reception signal processing section
112 frame analysis section
113 reception buffer

1. A wireless communication apparatus, comprising:
a setting section that sets thresholds of a plurality of levels for a received electric field strength of a detected signal;
a detection section that detects that the detected signal is an existing system signal of a predetermined existing system;
a measurement section that measures a received electric field strength of the existing system signal; and
a communication control section that transmits a predetermined signal to another surrounding wireless communication apparatus when the measured received electric field strength exceeds a threshold of the predetermined existing system among the thresholds of the plurality of levels.

2. The wireless communication apparatus according to claim 1, wherein
the thresholds of the plurality of levels include at least a detection threshold that is used to determine detection of the existing system signal, and a report threshold that has a larger level than the detection threshold and is used to determine a need to report the detection of the existing system signal.

3. The wireless communication apparatus according to claim 1, wherein
the setting section measures a noise level value from the received electric field strength of the detected signal and sets the thresholds of the plurality of levels on a basis of the noise level value.

4. The wireless communication apparatus according to claim 2, wherein
the communication control section transmits a report signal that reports the detection of the existing system signal to the other wireless communication apparatus when the measured received electric field strength exceeds the report threshold.

5. The wireless communication apparatus according to claim 4, wherein
the communication control section transmits the report signal that includes at least a signal format of the existing system signal, a detection timing, and a detection value of the received electric field strength.

6. The wireless communication apparatus according to claim 4, wherein
the communication control section transmits a response signal for a request signal when the request signal indicating a report request transmitted from the other wireless communication apparatus is received.

7. The wireless communication apparatus according to claim 6, wherein
the communication control section transmits the response signal that includes at least a signal format of the existing system signal, a detection timing, and a detection value of the received electric field strength.

8. The wireless communication apparatus according to claim 2, wherein
the communication control section transmits a request signal indicating a report request to the other wireless communication apparatus when the measured received electric field strength exceeds the detection threshold.

9. The wireless communication apparatus according to claim 8, wherein
the communication control section transmits the request signal that includes at least a signal format of the existing system signal to be requested, a detection timing, and a detection value of the received electric field strength.

10. The wireless communication apparatus according to claim 8, wherein
the communication control section transmits the request signal to the other wireless communication apparatus also when a predetermined period of time elapses after the last transmission of the request signal.

11. The wireless communication apparatus according to claim 8, wherein
when a report signal that reports detection of the existing system signal transmitted from the other wireless communication apparatus is received, the communication control section transmits the report signal.

12. The wireless communication apparatus according to claim 8, wherein
when a report signal that reports detection of the existing system signal transmitted from the other wireless communication apparatus is received, and the measured received electric field strength exceeds a noise level value, the communication control section transmits the request signal.

13. The wireless communication apparatus according to claim 1, further comprising
a multilink management section that manages a plurality of links for performing communication, wherein
the communication control section transmits the predetermined signal to the other wireless communication apparatus by using a link in which the existing system signal is not detected, among the plurality of links.

14. The wireless communication apparatus according to claim 1, wherein
the setting section transmits and receives the thresholds of the plurality of levels to and from the other wireless communication apparatus, to set the thresholds of the plurality of levels.

15. The wireless communication apparatus according to claim 14, wherein
the setting section transmits and receives the thresholds of the plurality of levels to and from the other wireless communication apparatus during association, to set the thresholds of the plurality of levels.

16. The wireless communication apparatus according to claim 14, wherein
when at least one of the thresholds of the plurality of levels changes, the setting section transmits and receives the thresholds of the plurality of levels to and from the other wireless communication apparatus, to set the thresholds of the plurality of levels.

17. The wireless communication apparatus according to claim 1, further comprising
a storage section that stores a signal format of the detected existing system signal, a detection timing, and a detection value of the received electric field strength.

18. The wireless communication apparatus according to claim 1, wherein
the existing system signal is a signal of a primary system, a public communication system, an independent near field communication system, or a global positioning system.

19. The wireless communication apparatus according to claim 1, further comprising
a storage section that stores a signal format of the detected existing system signal, a detection timing, and a detection value of the received electric field strength, wherein
when the existing system signal is a signal of a primary system, the communication control section transmits the predetermined signal that includes at least the signal format of the existing system signal, the detection timing, and the detection value of the received electric field strength.

20. A wireless communication method for a wireless communication apparatus, the wireless communication method comprising:
setting thresholds of a plurality of levels for a received electric field strength of a detected signal;
detecting that the detected signal is an existing system signal of a predetermined existing system;
measuring a received electric field strength of the existing system signal; and
transmitting a predetermined signal to another surrounding wireless communication apparatus when the measured received electric field strength exceeds a threshold of the predetermined existing system among the thresholds of the plurality of levels.
